(19) United States
(12) Patent Application Publication
(10) Pub. No.: US 2005/0205642 A1
(43) Pub. Date: Sep. 22, 2005

(54) PCB manufacturing system

(76) Inventor: Duck-kyun Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/072,275

(22) Filed: Mar. 7, 2005

(30) Foreign Application Priority Data
Mar. 17, 2004 (KR) 2004-17947

(51) Int. Cl. B23K 37/00

(52) U.S. Cl. 228/8

(57) ABSTRACT

A manufacturing system to mount at least one component on a PCB includes a keeping part to keep the PCB, an input part to which a user inputs manufacturing information on the PCB, a display to display image data, a mount state detector to detect a mount state of the component, and a rework controller to determine whether the mount state is defective by comparing the detected result of the mount state detector with a predetermined propriety reference to store information on the defective mount state and to keep the PCB having the defective mount state in the keeping part and to display image data corresponding to the information of the defective mount state on the display if the manufacturing information on the PCB kept in the keeping part is input through the input part.

### CROSS-REFERENCE TO RELATED APPLICATIONS

This application claims the benefit of Korean Patent Application No. 2004-17947, filed Mar. 17, 2004 in the Korean Intellectual Property Office, the disclosures of which are incorporated herein by reference.

### BACKGROUND OF THE INVENTION

1. Field of the Invention

The present general inventive concept relates to a printed circuit board (PCB) manufacturing system, and more particularly, to a PCB manufacturing system to examine a surface mount state of a PCB.

2. Description of the Related Art

A PCB manufacturing system includes units to perform a mounting process and an examining process. After a PCB is processed in the mounting process, the PCB is transmitted to an examining device so that a surface mount state is examined in the examining process.

FIG. 1 is a schematic block diagram of a conventional examining device to examine a surface mount state of a PCB 100. Referring to FIG. 1, the examining device includes an optical examining part 101, a marking part 103, a transmitting part 105 and a keeping (storage) part 107.

The optical examining part 101 obtains image data on a surface mount state of the PCB 100 using an optical device and detects a defective part of the PCB 100 using a signal to process the image data. Here, the surface mount state to be examined includes a position of a mounted component, the quantity of solder, an electric disconnection, a short circuit and the like. The optical examining part 101 transmits information on a defective part of the PCB to the marking part 103.

The marking part 103 indicates the defective part that the optical examining part 101 determines as defective, using ink so that the defective part is distinguished from other parts.

The transmitting part 105 transmits the PCB 100 on which the indication of the defective part is completed, to the keeping part 107 so that the PCB having the defective part is stored in the keeping part 107.

An operator of the examining device confirms an ink mark on the defective part of the PCB 100 with the naked eye and repairs the PCB 100.

However, the ink mark to indicate the defective part may have a difficulty in confirming the defective part or may cause a quality deterioration. Further, after confirming the defective part, an additional process to remove the ink mark is required, thereby reducing a work-efficiency. Thus, the conventional PCB manufacturing system is not efficient to manage the information on the defective part of the PCB 100.

### SUMMARY OF THE INVENTION

In order to solve the foregoing and/or other problems, it is an aspect of the present general inventive concept to provide a printed circuit board (PCB) manufacturing system in which information on a defective part of a PCB is managed and transmitted with efficiency.

Additional aspects and/or advantages of the general inventive concept will be set forth in part in the description which follows and, in part, will be obvious from the description, or may be learned by practice of the general inventive concept.

The foregoing and/or other aspects of the present invention may be achieved by providing a manufacturing system to mount at least one component on a PCB, the manufacturing system including a keeping (storage) part to keep the PCB, an input part to which a user inputs manufacturing information on the PCB, a display to display image data, a mount state detector to detect a mount state of the at least one component, and a rework controller to determine whether the mount state of at least one component is defective by comparing the detected result of the mount state detector with a predetermined propriety reference to store information on the defective mount state, to keep the PCB having the defective mount state in the keeping part and to display information corresponding to the stored information of the defective mount state on the display if the manufacturing information on the PCB kept in the keeping part is input through the input part.

According to an aspect of the general inventive concept, the input part may include a carrying-out sensor to sense whether the PCB kept in the keeping part is carried out, and the manufacturing information may include a sensing signal of the carrying-out sensor.

According to another aspect of the invention, the rework controller indicates a bar code to distinguish the PCB having the defective mount state from other PCBs and keeps the PCB having the defective mount state in the keeping part, and the carrying-out sensor senses indicating information of the barcode when the PCB is carried out.

According to yet another aspect of the invention, the manufacturing information may include detecting requirement information to detect the information on the defective mount state.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a conventional examining device to examine a surface mount state of a PCB;

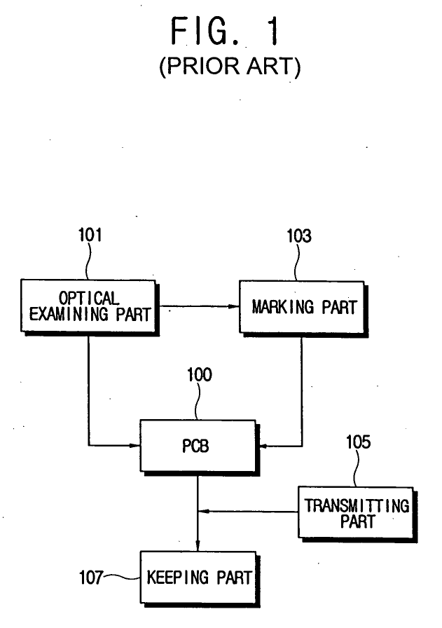

FIG. 2 is a schematic block diagram of a PCB manufacturing system according to an embodiment of the present general inventive concept; and

FIG. 3 is a schematic block diagram of a PCB manufacturing system according to another embodiment of the present general inventive concept.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

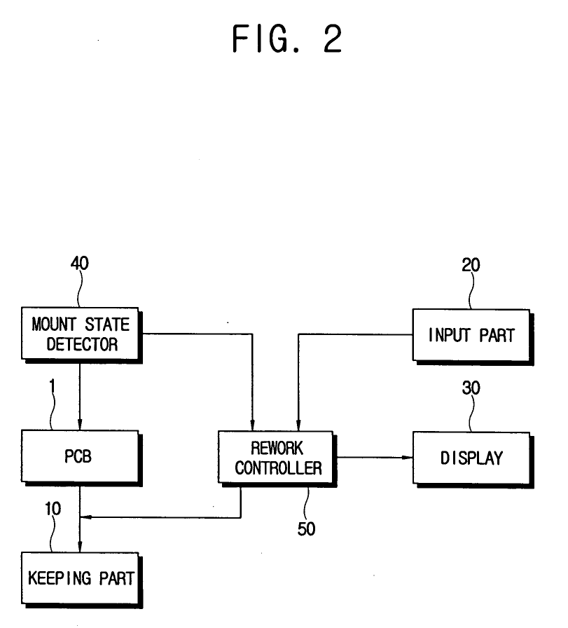

FIG. 2 is a schematic block diagram of a printed circuit board (PCB) manufacturing system according to an embodiment of the present general inventive concept. Referring to FIG. 2, the PCB manufacturing system may include a keeping (storage) part 10, an input part 20, a display 30, a mount state detector 40 and a rework controller 50.

The keeping part 10 can keep a printed circuit board (PCB) during a manufacturing process, the input part 20 can serve to input data on manufacturing of the PCB 1 therein, and the display 30 can display image data. The mount state detector 40 can detect a mounting state of components mounted on the PCB 1. The mount state detector 40 can examine positions of the components mounted on the PCB 1, the quantity of solder, an electric disconnection, a short circuit and the like. The examination of the mounting state may be performed by using an optical device to prevent a secondary defective, but not limited thereto. Physical/chemical and electrical tests may be applied to the examination of the mounting state of the PCB 1.

The rework controller 50 can determine whether the PCB 1 or the component is defective, and can control information on the defective PCB 1 or the defective component.

Hereinbelow, an operation of the PCB manufacturing system and functions of the rework controller 50 will be described with reference to FIG. 2.

An examination process can be performed according to manufacturing information inputted through the input part 20 by a user after a mounting process on the PCB 1.

In the examination process, the mount state detector 40 can collect image information of the PCB 1 to be examined and can transfer the information to the rework controller 50.

The rework controller 50 can analyze the inputted image information of the PCB 1 and can determine whether the image information is greater than or different from a propriety reference that is previously set. For example, the rework controller 50 compares the quantity of solder used for soldering the mounted components to a reference quantity of the solder by analyzing the image information of the PCB 1. If the used quantity of the solder is less than the reference quantity, the examined PCB 1 is determined as defective. The propriety reference may include an exact position of a component, a soldering position of a solder, the quantity of the solder and the like.

Thereafter, the rework controller 50 can transmit the defective PCB 1 to the keeping part 10 to keep the defective PCB 1 therein and stores detailed information on the defective state in a memory (not shown). As an aspect of the present general inventive concept, the information on the defective state may be arranged in a database to efficiently manage the information on a plurality of PCBs. The keeping part 10 can keep the defective PCBs and may include a work stand to repair the PCB 1 thereon.

If a user wants to rework the PCB 1 kept in the keeping part 10 or read the information on the PCB 1 kept in the keeping part 10, the user may need to access the information on the defective PCB 1. In order to perform reworking on the defective PCB 1, the user may require to read the information on a list of the kept PCBs, a defective position, the degree of the defective and the like through the input part 20.

Upon reading the information, the rework controller 50 can detect the stored information on the defective PCB 1 and displays the image data corresponding to the information of the defective PCB 1 on the display 30. According to an aspect of the present general inventive concept, the information on the defective PCB 1 may be transmitted as audio information.

The user may require information on a specific PCB to repair the specific PCB. If the required information is input through the input part 20, the rework controller 50 may display the required information on the display 30. The required information may be continually displayed as visual information or provided as audio information so that the required information is continually displayed on the defective state during the repair.

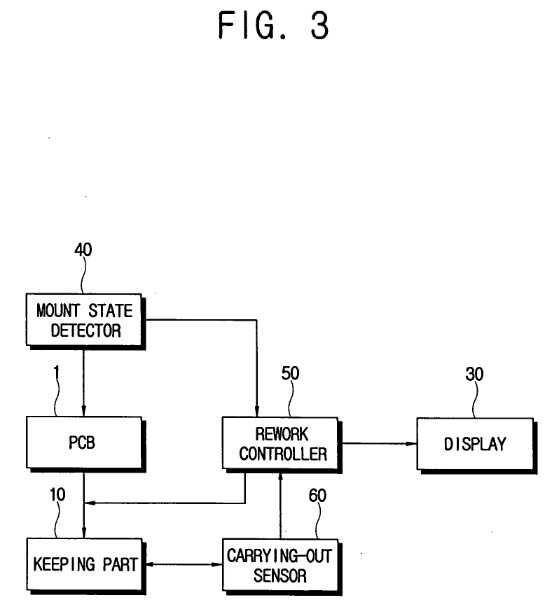

FIG. 3 is a schematic block diagram of a PCB manufacturing system according to another embodiment of the present general inventive concept. As shown in FIG. 3, the PCB manufacturing system may include a keeping (storage) part 10, a display 30, a mount state detector 40, a rework controller 50 and a carrying-out sensor 60.

The carrying-out sensor 60 may sense whether a PCB 1 kept in the keeping part 10 is carried out of the keeping part 10. The carrying-out sensor 60 may be implemented by using an optical sensor, a pressure sensor or the like.

A sensing signal sensed by the carrying-out sensor 60 can be transmitted to the rework controller 50. If the sensing signal to indicate that the PCB 1 is carried out is input, the rework controller 50 can display the image data corresponding to the information of the defective PCB 1 on the display 30.

In the embodiment shown in FIG. 2, a keyboard, a mouse and the like are usually used as the input part 20. However, the carrying-out sensor 60 of the embodiment shown in FIG. 3, serves as a special input device through which a requirement for a rework process is input. Thus, the rework controller 50 can recognize that the rework process of the PCB 1 is performed if the PCB 1 is carried out from the keeping part 10, and can display the image data corresponding to the information on the defective PCB 1.

To distinguish the defective PCB 1 from other PCBs, a bar code may be used. Then, the carrying-out sensor 60 may include a bar code reader, which is convenient to keep and manage the PCB 1.

According to the present general inventive concept, the information on the defective PCB may be systemically managed, thereby preventing the defective PCB from being additionally defected during performing the examination process and a repairing process.

Although a few embodiments of the present invention have been shown and described, it will be appreciated by those skilled in the art that changes may be made in these embodiments without departing from the principles and spirit of the invention, the scope of which is defined in the accompanying claims and their equivalents.

1. A manufacturing system to mount at least one component on a PCB, the manufacturing system comprising:
a keeping part to keep a PCB;
an input part to which a user inputs manufacturing information on the PCB;
a display to display image data;
a mount state detector to detect a mount state of a component mounted on the PCB; and
a rework controller to determine whether the mount state of the component is defective by comparing the detected result of the mount state detector with a predetermined propriety reference, to store information on the defective mount state, to keep the PCB having the defective mount state in the keeping part, and to display the image data corresponding to the information of the defective mount state on the display if the manufacturing information on the PCB kept in the keeping part is input through the input part.

2. The manufacturing system according to claim 2, wherein the input part comprises a carrying-out sensor to sense whether the PCB kept in the keeping part is carried out from the keeping part, and the manufacturing information comprises a sensing signal of the carrying-out sensor.

3. The PCB manufacturing system according to claim 2, wherein the rework controller generates a bar code to be marked on the PCB to identify the PCB having the defective mount state and keeps the PCB having the defective mount state in the keeping part, and
the carrying-out sensor senses indicating information of the barcode when the PCB is carried out.

4. The PCB manufacturing system according to claim 1, wherein the manufacturing information comprises detecting requirement information to detect the information on the defective mount state.

5. The manufacturing system according to claim 1, wherein the rework controller generates a bar code corresponding to the information.

6. The manufacturing system according to claim 5, wherein the bar code comprises an identification of at least one of the mounted component and the PCB.

7. The manufacturing system according to claim 5, wherein the bar code comprises information about a location of the defective component and at least one of a degree of the defective mount state, a quantity of solder, an electrical connection, and a short circuit.

8. The manufacturing system according to claim 5, wherein the bar code is disposed on the PCB.

9. The manufacturing system according to claim 8, wherein the bar code is disposed on a first position of the PCB other than a second position of the PCB on which the mounted component is located.

10. The manufacturing system according to claim 1, wherein the mount state comprises at least one of a degree of the defective mount state, a quantity of solder, an electrical connection, and a short circuit, and the reference comprises at least one sub-reference corresponding to the at least one of the degree of the defective mount state, the quantity of solder, the electrical connection, and the short circuit.

11. The manufacturing system according to claim 1, wherein the image data includes information about a location of the defective component and at least one of a degree of the defective mount state, a quantity of solder, an electrical connection, a short circuit, and identifications of the mounted component and the PCB.

12. The manufacturing system according to claim 1, wherein the rework controller disposes the image data corresponding to the information on the PCB, and the rework controller comprises a device to read the image data of the PCB and performs a rework process according to the read image data.

13. The manufacturing system according to claim 12, wherein the device comprises an optical sensor or a pressure sensor.

14. The manufacturing system according to claim 1, wherein the image data comprises a bar code, and the rework controller comprises a bar code reader to read the bar code from the PCB so that a rework process is performed according to the read bar code.

15. The manufacturing system according to claim 1, wherein the rework controller performs a rework process on the defective PCB according to the generated image data.

16. The manufacturing system according to claim 1, wherein the image information comprises an amount of a defective state of the mounted component of the PCB.

17. The manufacturing system according to claim 1, wherein the defective mount state comprises an amount of a defective state of the PCB.
